(19) United States
(12) Patent Application Publication
(10) Pub. No.: US 2019/0210490 A1
(43) Pub. Date: Jul. 11, 2019

(54) CLUTCH UNIT

(71) Applicant: NTN CORPORATION, Osaka (JP)

(72) Inventor: Koji SATO, Shizuoka (JP)

(21) Appl. No.: 16/325,462

(22) PCT Filed: Jul. 31, 2017
(86) PCT No.: PCT/JP2017/027624

§ 371 Date: Feb. 14, 2019

(30) Foreign Application Priority Data
Aug. 31, 2016 (JP) 2016-169097

(51) Int. Cl. B60N 2/18; F16D 67/02; F16D 41/02; F16D 41/10

(52) U.S. Cl. CPC B60N 2/1892; F16D 67/02; B60N 2/1615; F16D 41/105; F16D 41/02

(57) ABSTRACT

A brake-side clutch part to transmit a rotational torque input from a lever-side clutch part to an output side, and interrupt a rotational torque reversely input from the output side includes an inner ring, an outer ring including a recess/protrusion part, an output shaft, an engaging element including a recess/protrusion part capable of meshing with the recess/protrusion part, and a control mechanism to engage the engaging element with the outer ring through meshing between the recess/protrusion part and the recess/protrusion part when the rotational torque is interrupted, and disengage the engaging element from the outer ring through release of the meshing when the rotational torque is transmitted. The control mechanism includes a support part, which is provided between the engaging element and the inner ring, and is configured to maintain an engagement state between the engaging element and the outer ring when the rotational torque is interrupted.

### TECHNICAL FIELD

The present invention relates to a clutch unit comprising a lever-side clutch part, which is configured to receive a rotational torque input through a lever operation, and a brake-side clutch part, which is configured to transmit the rotational torque from the lever-side clutchpart to an output side and interrupt a rotational torque from the output side.

### BACKGROUND ART

In general, in a clutch unit using engaging elements such as cylindrical rollers or balls, a clutch part is arranged between an input member and an output member. The clutch part is configured to engage and disengage the engaging elements, such as cylindrical rollers or balls, between the input member and the output member, to thereby control transmission and interruption of a rotational torque.

The present applicant has previously proposed a clutch unit assembled to a seat lifter part for an automobile, which is configured to vertically adjust a seat through a lever operation (for example, see Patent Literature 1).

The clutch unit disclosed in Patent Literature 1 includes a lever-side clutch part, which is configured to receive a rotational torque input through a lever operation, and a brake-side clutch part, which is configured to transmit the rotational torque input from the lever-side clutch part to an output side and interrupt a rotational torque reversely input from the output side.

The lever-side clutchpart mainly includes an outer ring, an inner ring, cylindrical rollers, and a centering spring. The outer ring is configured to receive the rotational torque input through the lever operation. The inner ring is configured to transmit the rotational torque input from the outer ring to the brake-side clutch part. The cylindrical rollers are configured to control the transmission and interruption of the rotational torque from the outer ring through engagement and disengagement in wedge gaps between the outer ring and the inner ring. The centering spring is configured to accumulate an elastic force with the rotational torque input from the outer ring, and return the outer ring to a neutral state by the accumulated elastic force when the input of the rotational torque is lost.

The brake-side clutchpart mainly includes an inner ring, an outer ring, an output shaft, engaging elements, elastic members, and camparts. The inner ring is configured to receive the rotational torque input from the lever-side clutch part. The outer ring is constrained in rotation. The output shaft is configured to output the rotational torque. The engaging elements are mounted to the output shaft, and each include a recess/protrusion part capable of meshing with a recess/protrusion part of the outer ring. The elastic members are each configured to engage the engaging element with the outer ring through the meshing between the recess/protrusion part of the engaging element and the recess/protrusion part of the outer ring when the rotational torque is interrupted. The cam parts are each configured to disengage the engaging element from the outer ring by releasing the meshing between the recess/protrusion part of the engaging element and the recess/protrusion part of the outer ring when the rotational torque is transmitted.

In the lever-side clutch part, when the rotational torque is input to the outer ring through the lever operation, the cylindrical rollers are engaged with the wedge gaps between the outer ring and the inner ring. The rotational torque is transmitted to the inner ring thorough the engagement of the cylindrical rollers in the wedge gaps, thereby rotating the inner ring. On this occasion, as the outer ring rotates, the elastic force is accumulated in the centering spring.

When the input of the rotational torque through the lever operation is lost, the outer ring returns to the neutral state by the elastic force of the centering spring while the inner ring maintains a given rotational position. Thus, the inner ring rotates in an inching manner by repetition of the rotation of the outer ring, that is, a pumping operation on an operation lever.

In the brake-side clutch part, when the rotational torque is reversely input to the output shaft through seating on the seat, the engaging elements mounted to the output shaft are engaged with the outer ring through the meshing between the recess/protrusion parts of the engaging elements and the recess/protrusion part of the outer ring by the elastic forces of the elastic members, and the output shaft is thus locked to the outer ring. The rotational torque from the output shaft is interrupted through the locking of the output shaft. As a result, a seat surface height of the seat is maintained.

Meanwhile, when the rotational torque from the lever-side clutch part is input to the inner ring, the meshing between the recess/protrusion parts of the engaging elements and the recess/protrusion part of the outer ring is released against the elastic forces of the elastic members by the cam parts, and the engaging elements are thus disengaged from the outer ting. As a result of this disengagement of the engaging elements, the locked state of the output shaft is released, and the output shaft rotates through the engaging elements. That is, when the inner ring rotates in an inching manner, the output shaft also rotates in an inching manner. The inching rotation of the output shaft permits the vertical adjustment of the seat.

### CITATION LIST

Patent Literature 1: JP 2013-224692 A

### SUMMARY OF INVENTION

### Technical Problem

Incidentally, in the related-art clutch unit disclosed in Patent Literature 1, when the rotational torque is reversely input to the output shaft through seating on the seat, the engaging elements of the output shaft are engaged with the outer ring through the meshing between the recess/protrusion parts of the engaging elements and the recess/protrusion part of the outer ring by the elastic forces of the elastic members, and the output shaft is thus locked to the outer ring.

The rotational torque reversely input from the output shaft is locked in the brake-side clutch part through the locking of the output shaft, and the reverse transmission to the lever-side clutch part is interrupted. As a result, the seat surface height of the seat is maintained.

In the clutch unit assembled to the seat lifter part for an automobile, when a vertical vibration is generated during travelling of a vehicle on a rough road or the like in a seating state on the seat, a rotational torque in a forward direction and a rotational torque in a backward direction are reversely input in an alternate and continuous manner to the output shaft.

On this occasion, in the brake-side clutch part, the engaging elements are disengaged from the outer ring against the elastic forces of the elastic members due to a reaction force generated by the meshing between the recess/protrusion parts of the engaging elements and the recess/protrusion part of the outer ring so that the meshing between the recess/protrusion parts is released. Thus, the output shaft gradually rotates. As a result, there occurs such a phenomenon in which the seat is slightly lowered.

When the rotational torque is reversely input to the output shaft as described above, in order to avoid the situation in which the engaging elements are disengaged from the outer ring due to the reaction force generated by the meshing between the recess/protrusion parts of the engaging elements and the recess/protrusion part of the outer ring so that the meshing between the recess/protrusion parts is released, it is required to set a large load applied by the elastic members configured to elastically urge the engaging elements in a direction of engaging the engaging elements with the outer ring.

However, in a case in which the load applied by the elastic members is increased, when the rotational torque is input from the lever-side clutch part through the lever operation, the elastic members are compressed against the elastic forces in the brake-side clutch part, and a force of compressing the elastic members thus increases. As a result, a lever operation force increases in the lever-side clutch part, which causes degradation of operability.

The present invention has been made in view of the above-mentioned point to be improved, and therefore has an object to provide a clutch unit capable of reliably locking the output shaft without causing degradation of the operability even when rotational torques in forward and backward directions are reversely input in a continuous manner to the output shaft.

### Solution to Problem

According to one embodiment of the present invention, there is provided a clutch unit having a basic configuration comprising: a lever-side clutch part, which is provided on an input side, and is configured to control transmission and interruption of a rotational torque input through a lever operation; and a brake-side clutch part, which is provided on an output side, and is configured to transmit the rotational torque from the lever-side clutch part to the output side, and interrupt a rotational torque reversely input from the output side.

According to one embodiment of the present invention, the brake-side clutch part comprises: an input member configured to receive the rotational torque input thereto; a stationary member, which comprises a recess/protrusion part, and is constrained in rotation; an output member configured to output the rotational torque; an engaging element, which comprises a recess/protrusion part capable of meshing with the recess/protrusion part of the stationary member, and is arranged on the output member; and a control mechanism configured to engage the engaging element with the stationary member through meshing between the recess/protrusion part of the engaging element and the recess/protrusion part of the stationary element when the rotational torque is interrupted, and disengage the engaging element from the stationary member through release of the meshing between the recess/protrusion part of the engaging element and the recess/protrusion part of the stationary element when the rotational torque is transmitted.

As a technical measure for achieving the above-mentioned object, according to one embodiment of the present invention, the control mechanism comprises a support part, which is provided between the engaging element and the input member, and is configured to maintain an engagement state between the engaging element and the stationary member when the rotational torque is interrupted.

In the present invention, the support part configured to maintain the engagement state between the engaging element and the stationary member is provided between the engaging element and the input member. Thus, when the output member is locked, a position of the engaging element can be maintained by the support part even when the rotational torques in forward and backward directions are reversely input in an alternate and continuous manner to the output member. Therefore, the engaging element can be prevented from being disengaged from the stationary member due to a reaction force generated by the meshing between the recess/protrusion parts. Thus, gradual rotation of the output member can be avoided, and the output member can reliably be locked.

According to one embodiment of the present invention, it is desired that the support part comprise protrusions formed respectively on the engaging element and the input member, and that the protrusion of the engaging element and the protrusion of the input member be arranged opposed to each other in an engagement/disengagement direction between the engaging element and the stationary element so as to be capable of being brought into abutment against each other.

In a case in which such a structure is employed, when the output member is locked, the position of the engaging element is easily maintained by the support part even when the rotational torques in forward and backward directions are reversely input in an alternate and continuous manner to the output member.

According to one embodiment of the present invention, it is desired that the control mechanism comprise: an elastic member, which is provided between the engaging element and the output member, and is configured to elastically urge the engaging element in a direction of engaging the engaging element with the stationary member; and a cam part, which is provided between the engaging element and the input member, and is configured to displace the engaging element in a direction of disengaging the engaging element from the stationary member against an elastic force of the elastic member.

In a case in which such a structure is employed, when the output member is locked, the position of the engaging element is easily maintained by the support part without increasing the load applied by the elastic member even when the rotational torques in forward and backward directions are reversely input in an alternate and continuous manner to the output member.

According to one embodiment of the present invention, it is desired that the brake-side clutch part comprise a brake member, which is mounted to the stationary member, and is configured to apply a rotational resistance to the output member when the rotational torque is input from the lever-side clutch part.

In a case in which such a structure is employed, the output member receives the rotational resistance from the stationary member by the brake member when the meshing between the recess/protrusion part of the engaging element and the recess/protrusion part of the stationary member is released at the time of input of the rotational torque through the lever operation. Thus, the output member can be prevented from suddenly rotating.

In the clutch unit according to one embodiment of the present invention, the lever-side clutch part and the brake-side clutch part are assembled to a seat lifter part for an automobile. With such a structure, the clutch unit is suitable for use in an automobile.

### Advantageous Effects of Invention

According to the present invention, the support part configured to maintain the engagement state between the engaging element and the stationary member is provided between the engaging element and the input member. Thus, when the output member is locked, the position of the engaging element can be maintained by the support part even when the rotational torques in forward and backward directions are reversely input in an alternate and continuous manner to the output member. Therefore, the engaging element can be prevented from being disengaged from the stationary member due to the reaction force generated by the meshing between the recess/protrusion parts. Thus, the gradual rotation of the output member can be avoided, and the output member can reliably be locked.

As a result, in a case in which the brake-side clutch part is assembled to the seat lifter part for an automobile, even when a vertical vibration is generated during travelling of a vehicle on a rough road or the like in a seating state on the seat, occurrence of the phenomenon in which the seat is slightly lowered can be prevented. Moreover, excellent operability can be secured without an increase in the lever operation force in the lever-side clutch part.

### BRIEF DESCRIPTION OF DRAWINGS

FIG. 1 is a sectional view for illustrating an overall configuration of a clutch unit according to an embodiment of the present invention.

FIG. 2 is a sectional view taken along the line P-P in FIG. 1.

FIG. 3 is a sectional view taken along the line Q-Q in FIG. 1.

FIG. 4 is a sectional view taken along the line R-R in FIG. 1.

FIG. 5 is an assembly exploded perspective view for illustrating the clutch unit of FIG. 1 as viewed from an input side.

FIG. 6 is an assembly exploded perspective view for illustrating the clutch unit of FIG. 1 as viewed from an output side.

FIG. 7A is an enlarged sectional view for illustrating an interruption state of a rotational torque in an operation state of a control mechanism of FIG. 1.

FIG. 7B is an enlarged sectional view for illustrating a state immediately after release of the interruption state in the operation state of the control mechanism of FIG. 1.

FIG. 7C is an enlarged sectional view for illustrating a transmission state of the rotational torque in the operation state of the control mechanism of FIG. 1.

FIG. 8 is a configuration view for illustrating a seat for an automobile and a seat lifter part.

### DESCRIPTION OF EMBODIMENTS

Detailed description is now given of a clutch unit according to an embodiment of the present invention with reference to the drawings.

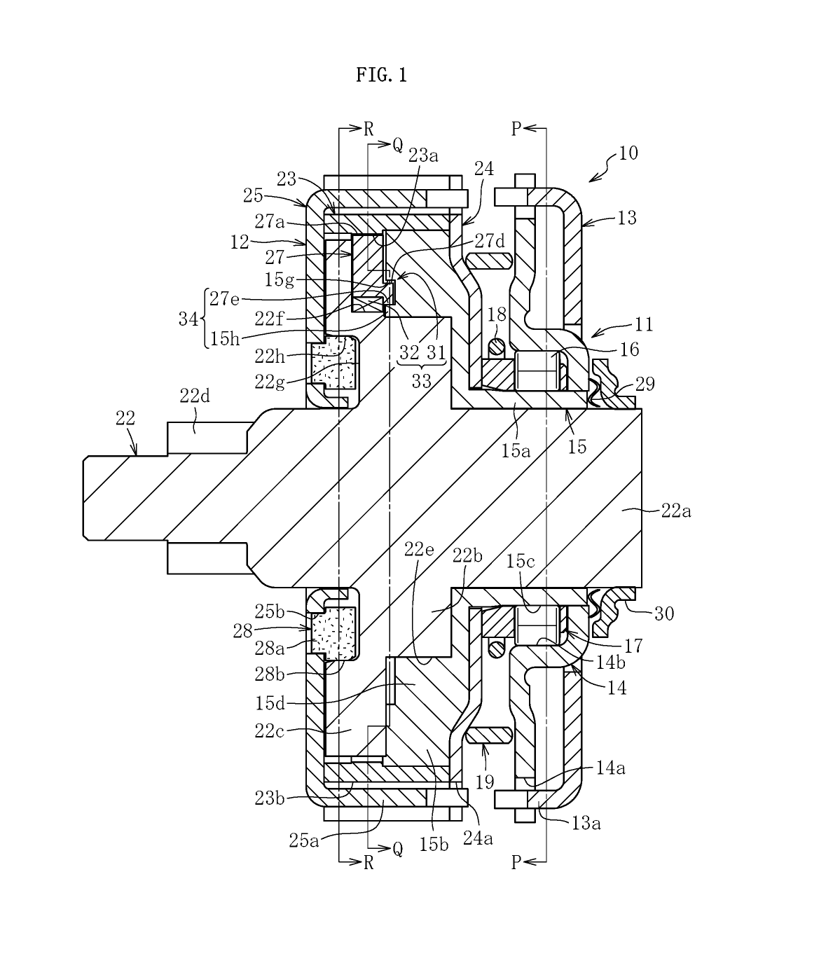

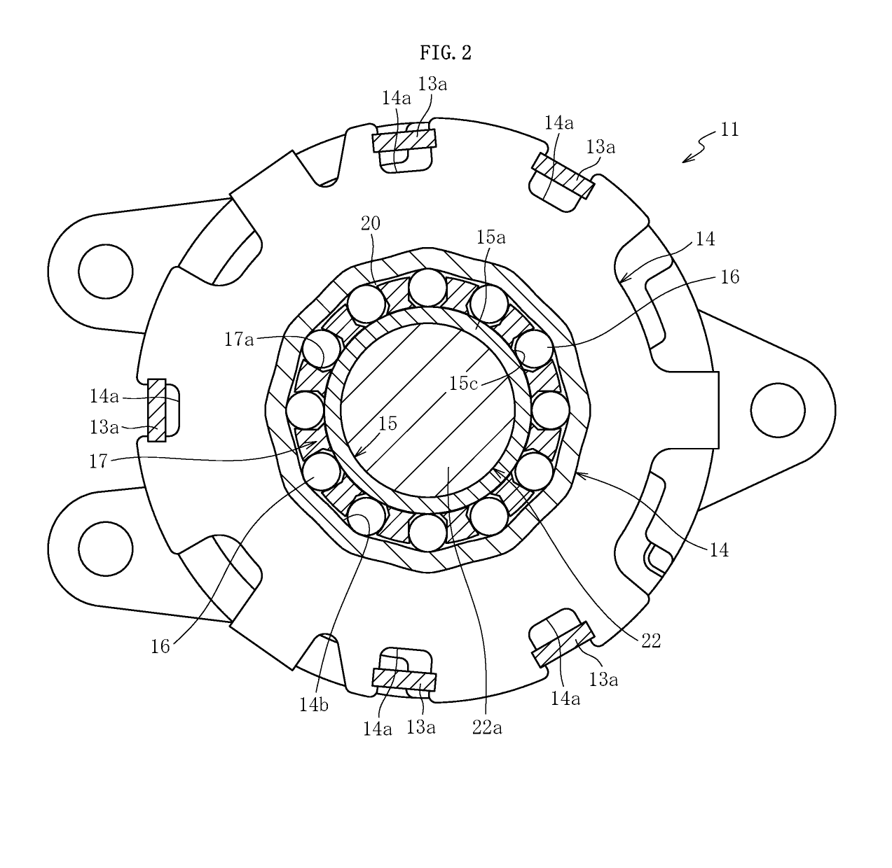

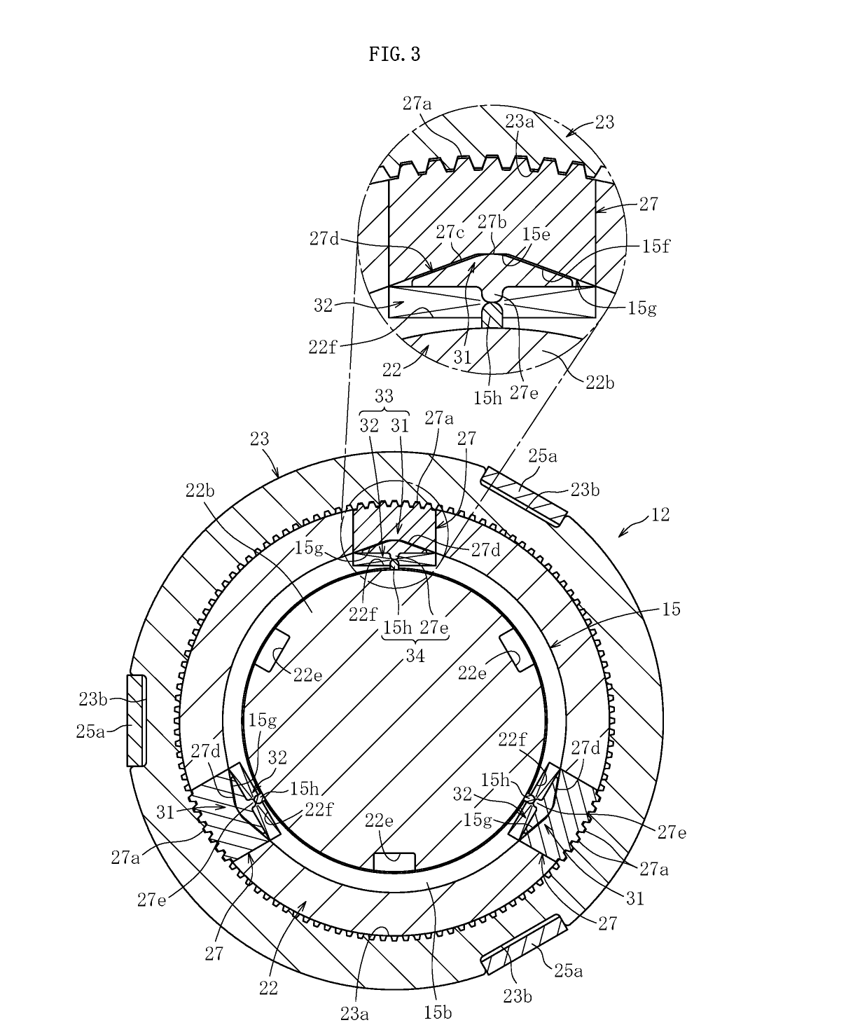

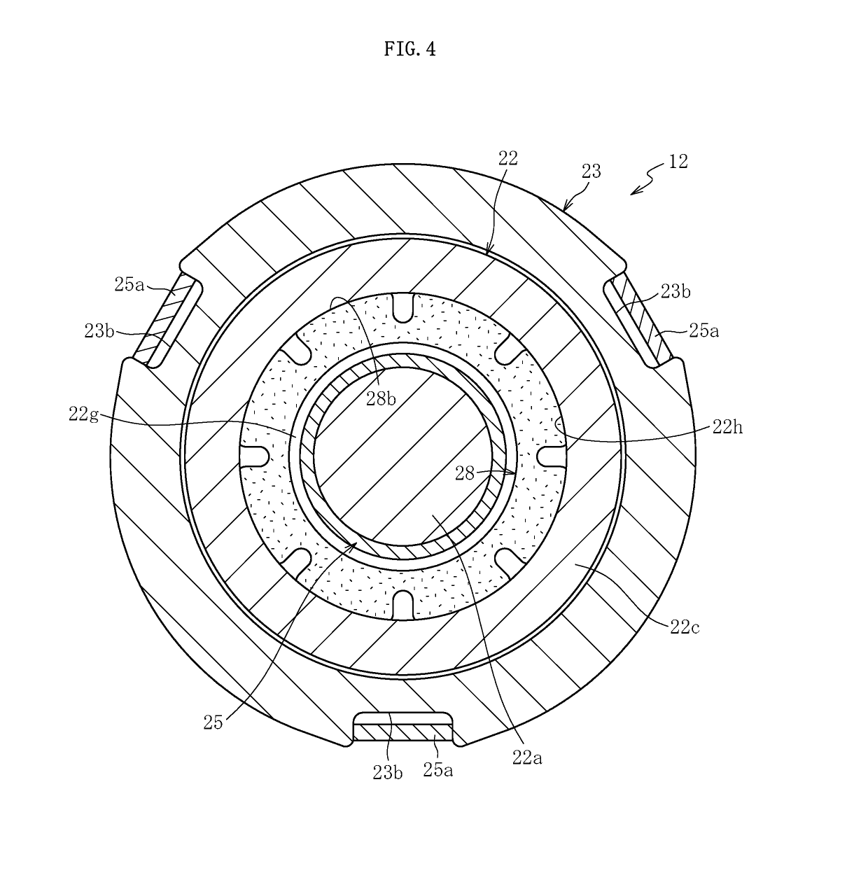

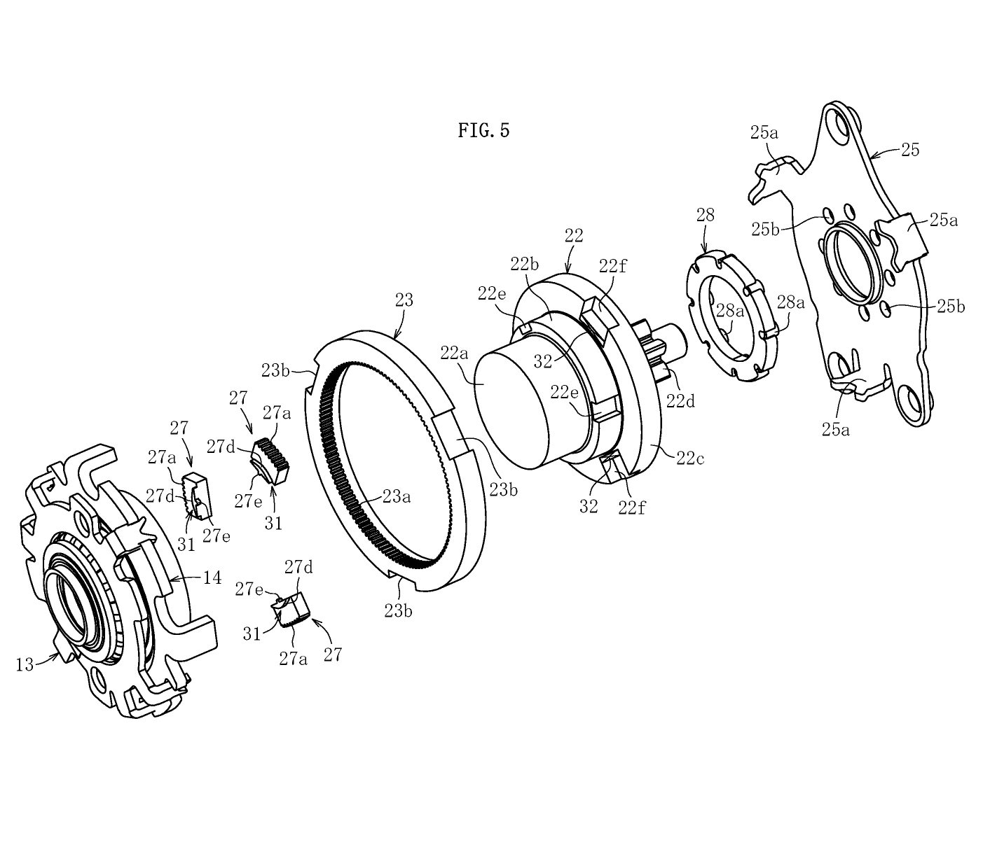

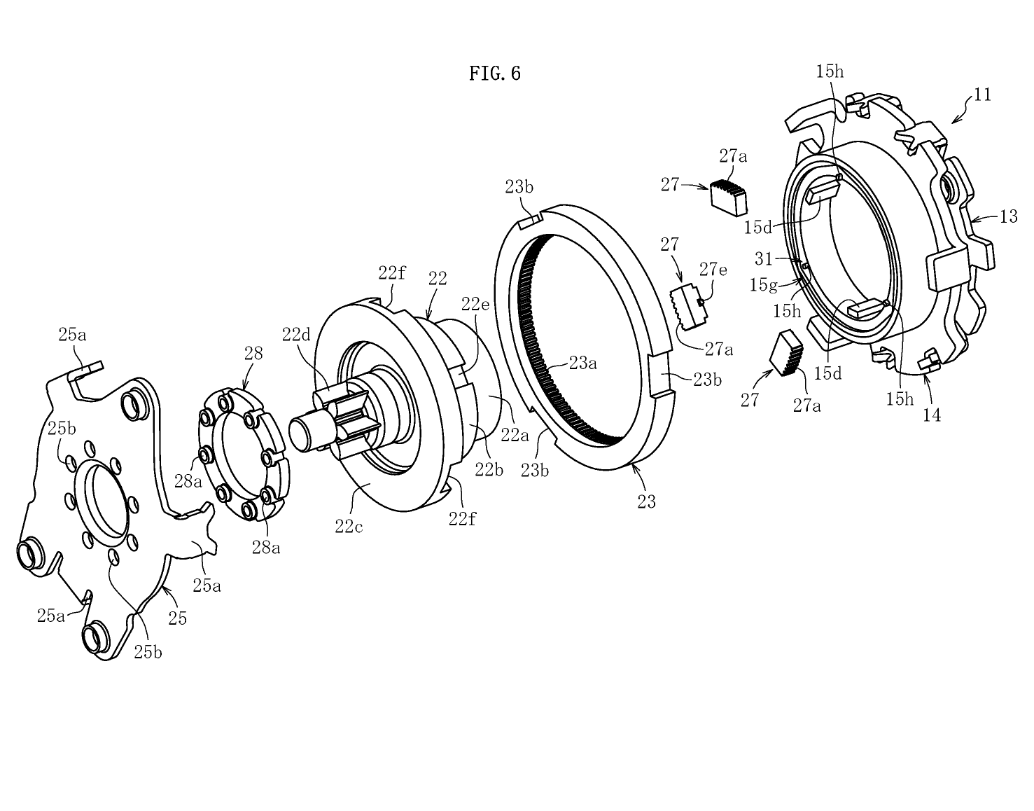

FIG. 1 is a sectional view for illustrating an overall configuration of the clutch unit according to this embodiment. FIG. 2 is a sectional view taken along the line P-P in FIG. 1. FIG. 3 is a sectional view taken along the line Q-Q in FIG. 1. FIG. 4 is a sectional view taken along the line R-R in FIG. 1. FIG. 5 is an assembly exploded perspective view for illustrating the clutch unit as viewed from an input side. FIG. 6 is an assembly exploded perspective view for illustrating the clutch unit as viewed from an output side.

As illustrated in FIG. 1, the clutch unit 10 according to this embodiment has a unit structure integrally comprising a lever-side clutch part 11 and a brake-side clutch part 12. The lever-side clutch part 11 is provided on an input side, and the brake-side clutch part 12 is provided on an output side. The lever-side clutch part 11 is configured to control transmission and interruption of a rotational torque input through a lever operation. The brake-side clutch part 12 has a reverse input interrupting function of transmitting the rotational torque input from the lever-side clutch part 11 to the output side and interrupting the rotational torque reversely input from the output side.

As illustrated in FIG. 1 and FIG. 2, the lever-side clutch part 11 mainly comprises a side plate 13, an outer ring 14, an inner ring 15, a plurality of cylindrical rollers 16, a cage 17, an inner centering spring 18, and an outer centering spring 19. The side plate 13 and the outer ring 14 are configured to receive the rotational torque input through the lever operation. The inner ring 15 is configured to transmit the rotational torque input from the outer ring 14 to the brake-side clutch part 12. The plurality of cylindrical rollers 16 are configured to control transmission and interruption of the rotational torque from the outer ring 14 through the engagement and disengagement between the outer ring 14 and the inner ring 15. The cage 17 is configured to retain the cylindrical rollers 16 at equal intervals in a circumferential direction. The inner centering spring 18 is configured to return the cage 17 to a neutral state. The outer centering spring 19 is configured to return the outer ring 14 to a neutral state.

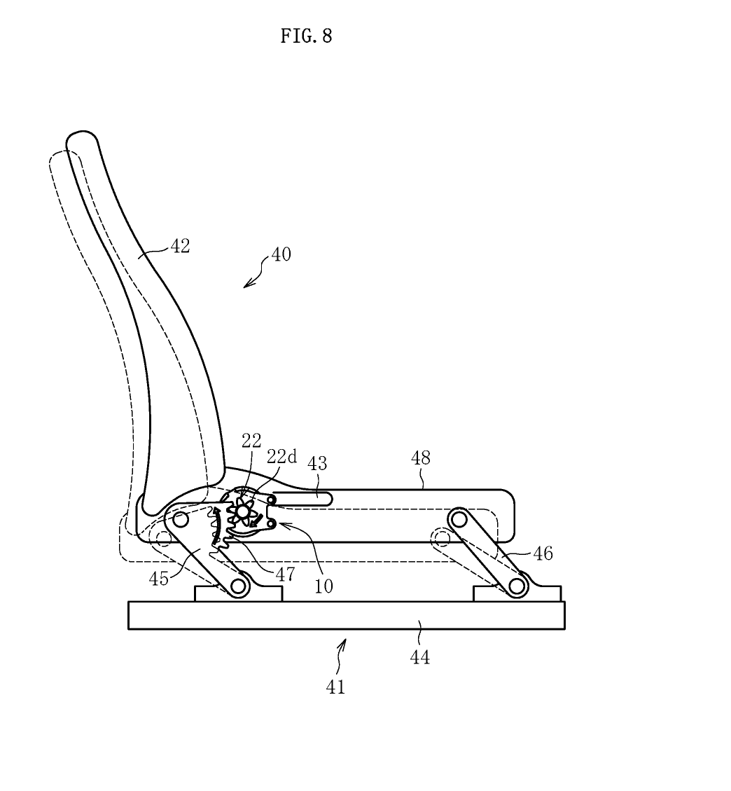

In the lever-side clutch part 11, the side plate 13 is fixed to the outer ring 14 by inserting claw parts 13a formed on an outer peripheral edge portion of the side plate 13 into cutout recessed parts 14a formed in an outer peripheral edge portion of the outer ring 14, and crimping the claw parts 13a. Thus, the side plate 13 and the outer ring 14 are formed into an integrated input member. A plurality of cam surfaces 14b are formed at equal intervals in the circumferential direction on an inner periphery of the outer ring 14. The input of the rotational torque to the outer ring 14 is performed through an operation lever 43 (see FIG. 8), which is mounted to the side plate 13 by screwing or the like and is swingable in a vertical direction.

The inner ring 15 comprises a small-diameter tubular part 15a and a large-diameter tubular part 15b. The small-diameter tubular part 15a is configured to receive an output shaft 22 inserted therethrough. The large-diameter tubular part 15b extends from the small-diameter tubular part 15a radially outward and bends in an axial direction. A wedge gap 20 is formed between an outer peripheral surface 15c of the small-diameter tubular part 15a of the inner ring 15 and each of the cam surfaces 14b formed on the inner periphery of the outer ring 14. The cylindrical rollers 16 are arranged in the wedge gaps 20 at the equal intervals in the circumferential direction by the cage 17.

The inner centering spring 18 is a C-shaped elastic member having a circular cross section provided between the cage 17 and a cover 24 of the brake-side clutch part 12. Both end portions of the inner centering spring 18 are locked to parts of the cage 17 and the cover 24. When the rotational torque input from the outer ring 14 through the lever operation is applied, the inner centering spring 18 is spread outward as the cage 17 following the outer ring 14 rotates relative to the cover 24 in a stationary state, and an elastic force is thus accumulated. When the rotational torque input from the outer ring 14 is released, the inner centering spring 18 returns the cage 17 to the neutral state by the elastic force.

The outer centering spring 19 positioned on a radially outer side with respect to the inner centering spring 18 is a C-shaped band-plate elastic member arranged between the outer ring 14 and the cover 24. Both end portions of the outer centering spring 19 are locked to parts of the outer ring 14 and the cover 24. When the rotational torque input from the outer ring 14 through the lever operation is applied, the outer centering spring 19 is spread outward as the outer ring 14 rotates relative to the cover 24 in a stationary state, and an elastic force is thus accumulated. When the rotational torque input from the outer ring 14 is released, the outer centering spring 19 returns the outer ring 14 to the neutral state by the elastic force.

The cage 17 is a cylindrical member made of resin in which a plurality of pockets 17a configured to receive the cylindrical rollers 16 are formed at the equal intervals in the circumferential direction. Both of the end portions of the inner centering spring 18 are locked to one end portion of the cage 17 in the axial direction, that is, an end portion of the brake-side clutch part 12 on the cover 24 side in the axial direction. The cage 17 is arranged between the outer ring 14 and the inner ring 15.

As illustrated in FIG. 1 and FIG. 3, the brake-side clutch part 12, which is of a type called “lock type”, mainly comprises the inner ring 15, an outer ring 23, the output shaft 22, a plurality of engaging elements 27, control mechanisms 33, and a friction ring 28. The inner ring 15 serves as an input member configured to receive a rotational torque input thereto. The outer ring 23 comprises a recess/protrusion part 23a, and serves as a stationary member constrained in rotation. The output shaft 22 serves as an output member configured to output the rotational torque. The plurality of engaging elements 27 each comprise a recess/protrusion part 27a capable of meshing with the recess/protrusion part 23a of the outer ring 23, and are provided on the output shaft 22. The control mechanisms 33 are each configured to engage the engaging element with the outer ring 23 through the meshing between the recess/protrusion part 27a of the engaging element 27 and the recess/protrusion part 23a of the outer ring 23 when the rotational torque is interrupted, and disengage the engaging element 27 from the outer ring 23 through the release of the meshing between the recess/protrusion part 27a of the engaging element 27 and the recess/protrusion part 23a of the outer ring 23 when the rotational torque is transmitted. The friction ring 28 serves as a brake member configured to apply a rotational resistance to the output shaft 22.

A large-diameter part 22b is integrally formed at a center portion of a shaft part 22a of the output shaft 22 in the axial direction. A flange part 22c is integrally formed on an output side of the large-diameter part 22b. A pinion gear 22d configured to be coupled to a seat lifter part 41 (see FIG. 8) is coaxially formed at an end portion of the shaft part 22a on an output side. A washer 30 is press-fitted to an end portion of the shaft part 22a on an input side through intermediation of a wave washer 29, thereby preventing removal of the components of the lever-side clutch part 11.

An inner peripheral surface of the large-diameter tubular part 15b of the inner ring 15 is held in slide contact with an outer peripheral surface of the large-diameter part 22b of the output shaft 22. Protruding parts 15d are formed at a plurality of positions of the large-diameter tubular part 15b of the inner ring 15 in the circumferential direction (see FIG. 1 and FIG. 6). The protruding parts 15d are inserted into recessed grooves 22e formed at a plurality of positions of the large-diameter part 22b of the output shaft 22 in the circumferential direction with a clearance in the circumferential direction. The rotational torque from the inner ring 15 can be transmitted to the output shaft 22 through the engagement in the circumferential direction between the protruding parts 15d and the recessed grooves 22e.

In the brake-side clutch part 12, the outer ring 23 and the cover 24 are fixed to the side plate 25 by inserting claw parts 25a formed on an outer peripheral edge portion of the side plate 25 into cutout recessed parts 23b formed in an outer peripheral edge portion of the outer ring 23 having a thick plate shape and into cutout recessed parts 24a formed in an outer peripheral edge portion of the cover 24, and crimping the claw parts 25a. As a result, the outer ring 23, the cover 24, and the side plate 25 are integrated to form a stationary member.

The recess/protrusion part 23a in a teeth form is formed on an inner peripheral surface of the outer ring 23 over the entire circumference. The inner peripheral surface of the outer ring 23 is slidably brought into abutment against the outer peripheral surface of the large-diameter tubular part 15b of the inner ring 15. The engaging element 27 is formed into a block shape. The recess/protrusion part 27a in a teeth form is formed on the outer peripheral surface of the engaging element 27 so as to be capable of meshing with the recess/protrusion part 23a of the outer ring 23. In this embodiment, the three engaging elements 27 are arranged at the equal intervals in the circumferential direction, but the number thereof is freely selected.

A cam part 31 is formed on an end surface of the engaging element 27 on an inner peripheral side so as to protrude toward one side in the axial direction (toward the side plate 13 side of the lever-side clutch part 11) (see FIG. 5). The engaging elements 27 are received in recessed portions 22f, which are formed on an outer peripheral surface of the flange part 22c of the output shaft 22, so as to freely retract into the recessed portions 22f in a radial direction. An elastic member 32 such as a coil spring or elastomer is interposed between a bottom surface of the recessed portion 22f and a bottom surface of the engaging element 27. The elastic member 32 is configured to elastically urge the engaging element 27 in a direction of engaging the engaging element 27 with the outer ring 23, that is, radially outward.

The recessed portion 22f of the flange part 22c of the output shaft 22 is opened in the axial direction, and the cam part 31 of the engaging element 27 is thus arranged so as to protrude from an end surface of the flange part 22c in the axial direction. The cam part 31 of the engaging element 27 comprises a cam surface 27d having a protruding shape. The cam surface 27d is formed of a crest portion 27b and inclined portions 27c. The crest portion 27b is arranged at a center of the cam surface 27d in the circumferential direction. The inclined portions 27c extend from the crest portion 27b toward both sides in the circumferential direction (see FIG. 3).

In contrast, the cam part 31 is formed also on an inner peripheral surface of an end portion of the large-diameter tubular part 15b of the inner ring 15. The cam part 31 of the inner ring 15 comprises a cam surface 15g having a recessed shape. The cam surface 15g is formed of a valley portion 15e and inclined portions 15f. The valley portion 15e is arranged at a center of the cam surface 15g in the circumferential direction. The inclined portions 15f extend from the valley portion 15e toward both sides in the circumferential direction (see FIG. 3 and FIG. 6).

In such a manner, the cam surface 27d of the engaging element 27 and the cam surface 15g of the large-diameter tubular part 15b of the inner ring 15 form the cam part 31 configured to displace the engaging element 27 in the direction of disengaging the engaging element 27 from the outer ring 23 against the elastic force of the elastic member 32. Moreover, the control mechanism 33 comprises the cam part 31 and the elastic member 32.

Meanwhile, a protrusion 27e protruding along an engagement/disengagement direction between the engaging element 27 and the outer ring 23 is formed on a bottom surface of the cam part 31 of the engaging element 27. In contrast, a protrusion 15h protruding along the engagement/disengagement direction between the engaging element 27 and the outer ring 23 is formed on an end surface of the large-diameter tubular part 15b of the inner ring 15 (see FIG. 6).

A support part 34 is formed with a configuration in which the protrusion 27e of the engaging element 27 and the protrusion 15h of the inner ring 15 are arranged opposed to each other in the engagement/disengagement direction between the engaging element 27 and the outer ring 23 so as to be capable of being brought into abutment against each other. The protrusions 15h of the inner ring 15 are formed on an end surface of the large-diameter tubular part 15b so as to protrude toward one side in the axial direction (toward the brake-side clutch part 12 side) so that the protrusions 15h are capable of being brought into abutment against the protrusions 27e of the engaging elements 27, respectively.

The friction ring 28 is a member which is formed into a ring shape by applying injection-molding or the like on a resin material. The friction ring 28 is fixed to the side plate 25 by inserting protrusions 28a formed at a plurality of positions in the circumferential direction into holes 25b of the side plate 25 (see FIG. 5 and FIG. 6).

As illustrated in FIG. 1 and FIG. 4, the friction ring 28 is press-fitted with interference to an inner peripheral surface 22h of an annular recessed part 22g formed in the flange part 22c of the output shaft 22. A rotational resistance is applied to the output shaft 22 by a friction force generated between an outer peripheral surface 28b of the friction ring 28 and the inner peripheral surface 22h of the annular recessed part 22g of the output shaft 22 when the lever is operated.

Description is now given of an operation example of the lever-side clutch part 11 and the brake-side clutch part 12 having the configuration described above.

In the lever-side clutch part 11, when the rotational torque is input to the outer ring 14 through the lever operation, the cylindrical rollers 16 are engaged with the wedge gaps 20 between the cam surfaces 14b of the outer ring 14 and the outer peripheral surface 15c of the inner ring 15. The rotational torque is transmitted to the inner ring 15 through the engagement of the cylindrical rollers 16 in the wedge gaps 20, thereby rotating the inner ring 15. On this occasion, as the outer ring 14 and the cage 17 rotate, the elastic forces are accumulated in both of the centering springs 18 and 19.

When the input of the rotational torque through the lever operation is lost, the cage 17 and the outer ring 14 return to the respective neutral states by the elastic forces of both of the centering springs 18 and 19. Meanwhile, the inner ring 15 maintains a given rotational position. Thus, the inner ring 15 rotates in an inching manner by repetition of the rotation of the outer ring 14, that is, a pumping operation on the operation lever 43.

Meanwhile, even when the rotational torque is reversely input to the output shaft 22 through seating on a seat 40 (see FIG. 8), the engaging elements 27 are urged radially outward in the protruding direction by the elastic forces of the elastic members 32 in the brake-side clutch part 12. Therefore, as illustrated in FIG. 3, the state in which the recess/protrusion parts 27a of the engaging elements 27 are engaged with the recess/protrusion part 23a of the outer ring 23, namely, the state in which the recess/protrusion parts 27a of the engaging elements 27 and the recess/protrusion part 23a of the outer ring 23 mesh with each other is brought about.

In such a manner, the output shaft 22 is locked to the outer ring 23 by bringing about the state in which the engaging elements 27 mounted to the output shaft 22 are engaged with the outer ring 23, which is a stationary system. As a result, the rotational torque reversely input from the output shaft 22 is locked by the brake-side clutch part 12, and reverse transmission to the lever-side clutch part 11 is interrupted. As a result, a seat surface height of the seat 40 is maintained.

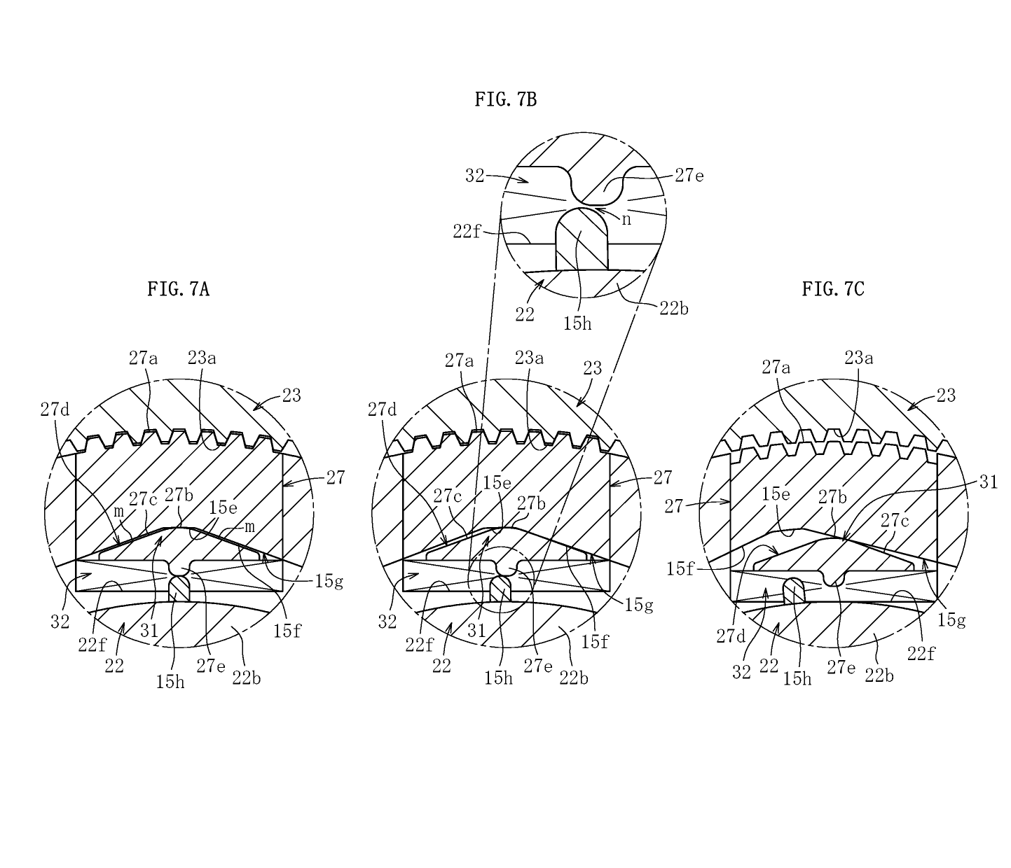

In this locked state of the output shaft 22, even when a vertical vibration is generated during travelling of a vehicle on a rough road or the like in the seating state on the seat 40, and the rotational torque in the forward direction and the rotational torque in the backward direction are reversely input in an alternate and continuous manner to the output shaft 22 as a result of the vertical vibration, as illustrated in FIG. 3 and FIG. 7A, the protrusions 15h of the inner ring 15 and the protrusions 27e of the engaging elements 27 are brought into the abutment state by the support parts 34, and the positions of the engaging elements 27 in the radial direction can thus easily be maintained.

Therefore, the engaging elements 27 can be prevented from being disengaged from the outer ring 23 due to the reaction force generated by the meshing between the recess/protrusion parts 27a of the engaging elements 27 and the recess/protrusion part 23a of the outer ring 23. Thus, the output shaft 22 can reliably be locked, and gradual rotation of the output shaft 22 can be avoided. As a result, such a phenomenon in which the seat 40 is slightly lowered can be prevented.

Moreover, it is not required to set a large load applied by the elastic members 32 configured to elastically urge the engaging elements 27 in the direction of engaging the engaging elements 27 with the outer ring 23 in order to avoid the situation in which the engaging elements 27 are disengaged from the outer ring 23 due to the reaction force generated by the meshing between the recess/protrusion parts 27a of the engaging elements 27 and the recess/protrusion part 23a of the outer ring 23 so that the meshing between the recess/protrusion parts 27a and 23a is released. That is, excellent operability can be secured without an increase in the lever operation force in the lever-side clutch part 11.

When the output shaft 22 is locked, the crest portion 27b of the cam surface 27d of the engaging element 27 comes into contact with the valley portion 15e of the cam surface 15g of the inner ring 15 in each of the cam parts 31, and a slight gap m is formed between the inclined portion 27c of the cam surface 27d of the engaging element 27 and the inclined portion 15f of the cam surface 15g of the inner ring 15.

When the inner ring 15 rotates, the valley portion 15e of the cam surface 15g of the inner ring 15 shows an arc-shaped path around a rotation center of the inner ring 15. Therefore, a radius of the contact portions between the crest portion 27b of the cam surface 27d of the engaging element 27 and the valley portion 15e of the cam surface 15g of the inner ring 15 does not change. Therefore, the engaging element 27 does not displace radially inward until the inclined portion 27c of the cam surface 27d of the engaging element 27 and the inclined portion 15f of the cam surface 15g of the inner ring 15 come into contact with each other.

Thus, even when the rotational torque from the lever-side clutch part 11 is input to the inner ring 15 through the lever operation, the state in which the engaging elements 27 are pressed radially outward by the elastic forces of the elastic members 32, that is, the state in which the recess/protrusion parts 27a of the engaging elements 27 and the recess/protrusion part 23a of the outer ring 23 mesh with each other can be maintained until the inner ring 15 rotates so that the inclined portions 27c of the cam surfaces 27d of the engaging elements 27 and the inclined portions 15f of the cam surfaces 15g of the inner ring 15 come into contact with each other.

As illustrated in FIG. 7B, when the inclined portions 27c of the cam surfaces 27d of the engaging elements 27 and the inclined portions 15f of the cam surfaces 15g of the inner ring 15 come into contact with each other, the protrusions 15h of the inner ring 15 also rotate, and hence a gap n is formed between each of the protrusions 15h of the inner ring 15 and each of the protrusions 27e of the engaging elements 27. The inclined portions 15f of the cam surfaces 15g of the inner ring 15 press the inclined portions 27c of the cam surfaces 27d of the engaging elements 27, and thus the engaging elements 27 start displacing radially inward against the elastic forces of the elastic members 32.

Further, as the inner ring 15 rotates, as illustrated in FIG. 7C, the protrusions 15h of the inner ring 15 are completely separated from the protrusions 27e of the engaging elements 27, and the engaging elements 27 displace radially inward against the elastic forces of the elastic members 32 until the recess/protrusion parts 27a of the engaging elements 27 are disengaged from the recess/protrusion part 23a of the outer ring 23. As a result, the state in which the meshing between the recess/protrusion parts 27a of the engaging elements 27 and the recess/protrusion part 23a of the outer ring 23 is released is brought about. Thus, the locked state of the output shaft 22 is released, and the output shaft 22 is brought into the rotatable state.

Under this state, the clearance between the protruding part 15d of the large-diameter tubular part 15b of the inner ring 15 and the recessed groove 22e of the large-diameter part 22b of the output shaft 22 decreases, and the protruding part 15d of the inner ring 15 is brought into abutment against the recessed groove 22e of the output shaft 22 in the rotational direction. As a result, the rotational torque from the lever-side clutch part 11 is transmitted to the output shaft 22, and the output shaft 22 thus rotates. In other words, when the inner ring 15 rotates in the inching manner, the output shaft 22 also rotates in the inching manner. As a result, the seat 40 can be vertically adjusted.

When the locked state of the output shaft 22 is released through the lever operation, the meshing between the recess/protrusion parts 27a of the engaging elements 27 and the recess/protrusion part 23a of the outer ring 23 is completely released, and the output shaft 22 is thus in the free state. On this occasion, the rotational resistance is applied to the output shaft 22 by the friction ring 28, and hence the output shaft 22 does not suddenly rotate.

The clutch unit 10 described above is used after being assembled to the seat lifter part 41 for an automobile, which is configured to adjust a height of the seat 40 through the lever operation. FIG. 8 is a view for illustrating the seat 40 installed in a cabin of an automobile.

As illustrated in FIG. 8, the seat 40 comprises a seating seat 48 and a backrest seat 42, and a height of a seat surface of the seating seat 48 is adjusted by the seat lifter part 41. The height adjustment of the seating seat 48 is performed through the operation lever 43 mounted to the side plate 13 of the lever-side clutch part 11 (see FIG. 1) in the clutch unit 10.

The seat lifter part 41 has the following structure. One ends of link members 45 and 46 are pivotably mounted to a slidable member 44. Another ends of the link members 45 and 46 are pivotably mounted to the seating seat 48. A sector gear 47 is provided integrally with another end of the link member 45. The sector gear 47 meshes with the pinion gear 22d of the output shaft 22 of the clutch unit 10.

For example, when the seat surface of the seating seat 48 is to be lowered, the locked state of the brake-side clutch part (see FIG. 1) is released through the lever operation in the lever-side clutch part 11, in other words, by swinging the operation lever 43 downward. When the brake-side clutch part 12 is unlocked, the seat surface of the seating seat 48 can smoothly be lowered by applying the appropriate rotational resistance to the output shaft 22 through the friction ring 28 (see FIG. 1).

As a result of the unlocking of the brake-side clutch part 12, the pinion gear 22d of the output shaft 22 of the brake-side clutch part 12 is turned clockwise (in a direction indicated by the arrow of FIG. 8) by a rotational torque transmitted from the lever-side clutch part 11 to the brake-side clutch part 12. Then, the sector gear 47 meshing with the pinion gear 22d swings counterclockwise (in a direction indicated by the arrow of FIG. 8). As a result, both of the link member 45 and the link member 46 tilt so that the seat surface of the seating seat 48 is lowered.

In such a manner, when the operation lever 43 is released after the height of the seat surface of the seating seat 48 is adjusted, the operation lever 43 swings upward by the elastic forces of both of the centering springs 18 and 19, and returns to an original position (neutral state). When the operation lever 43 is swung upward, the seat surface of the seating seat 48 is raised through an operation opposite to the operation described above. When the operation lever 43 is released after the height adjustment of the seating seat 48, the operation lever 43 swings downward, and returns to the original position (neutral state).

The present invention is not limited to the above-mentioned embodiment. As a matter of course, the present invention may be carried out in various modes without departing from the spirit of the present invention. The scope of the present invention is defined in claims, and encompasses equivalents described in claims and all changes within the scope of claims.

1. A clutch unit, comprising:
a lever-side clutch part, which is provided on an input side, and is configured to control transmission and interruption of a rotational torque input through a lever operation; and
a brake-side clutch part, which is provided on an output side, and is configured to transmit the rotational torque input from the lever-side clutch part to the output side, and interrupt a rotational torque reversely input from the output side,
wherein the brake-side clutch part comprises:
an input member configured to receive the rotational torque input thereto;
a stationary member, which comprises a recess/protrusion part, and is constrained in rotation;
an output member configured to output the rotational torque;
an engaging element, which comprises a recess/protrusion part capable of meshing with the recess/protrusion part of the stationary member, and is arranged on the output member; and
a control mechanism configured to engage the engaging element with the stationary member through meshing between the recess/protrusion part of the engaging element and the recess/protrusion part of the stationary element when the rotational torque is interrupted, and disengage the engaging element from the stationary member through release of the meshing between the recess/protrusion part of the engaging element and the recess/protrusion part of the stationary element when the rotational torque is transmitted, and
wherein the control mechanism comprises a support part, which is provided between the engaging element and the input member, and is configured to maintain an engagement state between the engaging element and the stationary member when the rotational torque is interrupted.

2. The clutch unit according to claim 1,
wherein the support part comprises protrusions formed respectively on the engaging element and the input member, and
wherein the protrusion of the engaging element and the protrusion of the input member are arranged opposed to each other in an engagement/disengagement direction between the engaging element and the stationary element so as to be capable of being brought into abutment against each other.

3. The clutch unit according to claim 1, wherein the control mechanism comprises:
an elastic member, which is provided between the engaging element and the output member, and is configured to elastically urge the engaging element in a direction of engaging the engaging element with the stationary member; and
a cam part, which is provided between the engaging element and the input member, and is configured to displace the engaging element in a direction of disengaging the engaging element from the stationary member against an elastic force of the elastic member.

4. The clutch unit according to claim 1, wherein the brake-side clutch part comprises a brake member, which is mounted to the stationary member, and is configured to apply a rotational resistance to the output member when the rotational torque is input from the lever-side clutch part.

5. The clutch unit according to claim 1, wherein the lever-side clutch part and the brake-side clutch part are assembled to a seat lifter part for an automobile.
